(19) United States
(12) Patent Application Publication
(10) Pub. No.: US 2025/0035925 A1
(43) Pub. Date: Jan. 30, 2025

(54) Head-Up Display Device

(71) Applicant: SHIMADZU CORPORATION, Kyoto-shi (JP)

(72) Inventor: Masato TANAKA, Kyoto-shi (JP)

(21) Appl. No.: 18/764,419

(22) Filed: Jul. 5, 2024

(30) Foreign Application Priority Data
Jul. 24, 2023 (JP) 2023-120188

(51) Int. Cl. G02B 27/01; G02B 27/09

(52) U.S. Cl. CPC G02B 27/0101; G02B 27/0955; G02B 27/0983; G02B 2027/0196

(57) ABSTRACT

A head-up display device that projects display light onto a windshield of a manned vehicle and directs the display light reflected by the windshield toward the observer's eyes to form a virtual image in front of the observer's eyes, includes: an image emitting unit for forming parallel light beams different in angle at each location on the image and emit the light beams as display light; a light guide for emitting the light beams as the display light by expanding the light beams while maintaining the parallelism thereof; and a correcting lens arranged on an optical path between the light guide and the windshield. The correcting lens has a curved surface shape that deflects a light transmission direction according to a curved surface shape of a reflective surface of the windshield so that the display light becomes parallel after being reflected by the windshield.

### CROSS-REFERENCE TO RELATED APPLICATIONS

This application claims priority under 35 U.S.C. § 119 to Japanese Patent Application No. 2023-120188 filed on Jul. 24, 2023, the entire disclosure of which is incorporated herein by reference in its entirety.

### BACKGROUND OF THE INVENTION

### Field of the Invention

The present disclosure relates to a head-up display (hereinafter may be abbreviated as “HUD”) device.

### Description of the Related Art

The following description sets forth the inventor's knowledge of the related art and problems therein and should not be construed as an admission of knowledge in the prior art.

An HUD device is a device for an observer, such as a pilot, to visually observe information, such as instrument information, while observing the front external view in a manned vehicle, such as an aircraft and an automobile.

Non-Patent Document 1 describes an HUD that directs the display light with information on the image displayed on a small display inside the HUD housing to the eyes of the observer by reflecting the light onto a plurality of mirrors and a windshield.

As the amount of information to be displayed by the HUD increases, there is a demand for a larger screen for the display by the HUD. On the other hand, as the screen size increases, the optical system also becomes larger, which makes it difficult for the HUD housing to fit into the installation space within the cabin or the vehicle body. As one solution, a method has been proposed, in which a light guide, which is an optical member composed of a flat plate member capable of expanding a light beam, is used, as described in Non-Patent Document 1.

### PRIOR ART DOCUMENT

### Patent Document

Patent Document 1: International Publication No. WO 2021/157044

### Non-Patent Document

Non-Patent Document 1: Tanaka, Arita, “Light Guide Technology Contributing to Miniaturization of Head-up Display (HUD),” Shimadzu Review, Shimadzu Corporation, Vol. 79, No. 3 and 4 (2022), published Mar. 20, 2023.

### SUMMARY OF THE INVENTION

The preferred embodiments of the present disclosure have been developed in view of the above-mentioned and/or other problems in the related art. The preferred embodiments of the present disclosure can significantly improve upon existing methods and/or apparatuses.

There are several types of light guides. Basically, display light is guided into the interior of a flat plate substrate and propagated through the substrate while being reflected between the two sides of the substrate, and a part of the display light is taken out of the substrate by using optical effects, such as refraction, reflection, and diffraction. In the aircraft HUD described in Non-Patent Document 1, the display light whose light beam is expanded by a light guide placed approximately horizontally is reflected by a combiner placed diagonally in front of the eyes of the observer with its upper part inclined toward the front (observer side), and reaches the eyes of the observer.

In such an aircraft HUD, the virtual image generated by display light can be effectively formed in front of the eyes of the observer. On the other hand, for an automotive HUD, it is desired to have a configuration in which the display light is reflected by the windshield of the automobile installing the HUD and guided to the eyes of the observer, without using a dedicated combiner, in order to achieve a large screen, cost reduction, etc. However, in the case where the virtual image optical system including the light guide used in the above-described aircraft HUD is employed in such an automobile HUD, there is a problem that the virtual image formed in front of the eyes of the observer is greatly distorted or the position at which the virtual image is observed is greatly shifted, depending on the viewpoint position of the observer, resulting in a decrease in visibility.

The present disclosure has been made to solve these problems, and its main object is to provide a head-up display device capable of reducing distortion, positional displacement, etc., of the HUD display due to differences in the viewpoint position of the observer, and providing a good display image to the observer.

A head-up display device according to one aspect of the present disclosure is a head-up display device that projects display light onto a windshield of a manned vehicle and directs the display light reflected by the windshield toward eyes of an observer to form a virtual image in front of the eyes of the observer.

The head-up display device includes:
an image emitting unit including an image forming unit for forming an image, the image emitting unit being configured to form parallel light beams different in angle at each location on the image and emit the light beams as display light;
   a light guide configured to emit the light beams as the display light emitted from the image emitting unit by expanding the light beams while maintaining parallelism of the light beams; and
   a correcting lens arranged on an optical path between the light guide and the windshield, the correcting lens having a curved surface shape that deflects a light transmission direction according to a curved surface shape of a reflective surface of the windshield so that the display light, in which the parallel light beams are expanded by the light guide, becomes parallel after being reflected by the windshield.

Generally, in a light guide that expands a light beam, the display light containing image information at a certain point on an image formed on a display portion propagates the inside of the substrate of the light guide and maintains the parallelism of the light beam when emitting from the substrate to the outside. On the other hand, for example, a windshield of an automobile has a relatively complex curved surface shape, and the light beam incident parallel to the reflective surface is not parallel after the reflection, and the traveling direction is scattered. This is the primary reason why the HUD display is significantly distorted or displaced when the observer's viewpoint shifts.

In contrast, in the above-described embodiment of the head-up display device of the present disclosure, the action of the correcting lens increases the degree of parallelism of the light beam in each field of view after being reflected by the windshield, regardless of the shape of the reflective surface of the windshield, and the degree of spreading of the light beams becomes almost uniform. Therefore, according to the above-described aspect of the head-up display device of the present disclosure, the distortion and/or the displacement of the HUD display can be prevented even if the observer's viewpoint position shifts, which can provide an HUD display with good visibility.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present disclosure are shown by way of example, and not limitation, in the accompanying figures.

FIG. 1 is a schematic configuration of optics in an HUD system according to one embodiment of the present disclosure.

FIG. 2 is a diagram showing one example of a schematic structure and an optical path of a light guide used in the HUD system according to the embodiment.

FIG. 3A and FIG. 3B are diagrams according to related arts showing examples of an optical path when image light is projected onto a flat combiner and a windshield without using the correcting lens of the present disclosure.

FIG. 4 is a diagram showing one example of an optical path in an HUD system according to the embodiment.

FIG. 5 is a top plan view showing a positional relation between a windshield and an observer in the HUD system according to the embodiment.

### DETAILED DESCRIPTION OF THE PREFERRED EMBODIMENTS

In the following paragraphs, some preferred embodiments of the present disclosure will be described by way of example and not limitation. It should be understood based on this disclosure that various other modifications can be made by those skilled in the art based on these illustrated embodiments.

An HUD system, which is one embodiment of the present disclosure, will be described with reference to the accompanying drawings.

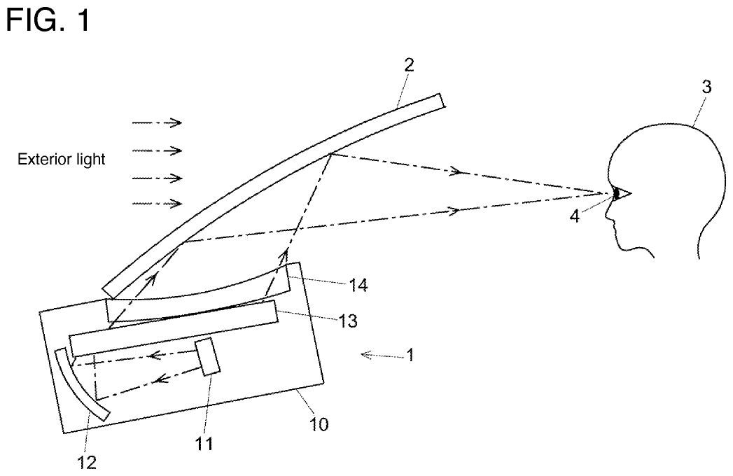

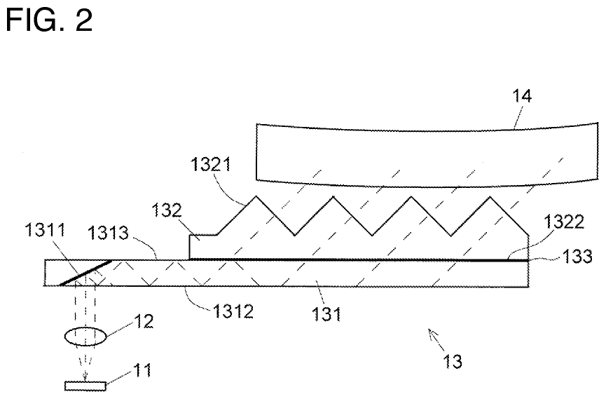

FIG. 1 is a schematic configuration of optics employed in the HUD system according to the embodiment. FIG. 2 is a diagram showing one example of a schematic structure and an optical path of a light guide shown in FIG. 1.

The HUD system 1 according to this embodiment is configured to typically form a virtual image including various instrumental information, etc., necessary for driving, so as to be superimposed on the external view in front of the eyes of an observer 3 who is driving an automobile. In front of the eyes of the observer 3, there is a windshield 2, which corresponds to a windshield of an automobile, and the HUD system 1 is positioned below it. The windshield 2 is a component necessary to form a virtual image, but the windshield 2 itself is not included in the HUD system 1 in this embodiment.

As shown in FIG. 1, the HUD system 1 is equipped with an image forming unit 11, an introductory optical system 12, a light guide 13, and a correcting lens 14, within a housing 10.

The image forming unit 11 forms a two-dimensional (still or moving) image of a display target and includes, for example, a light source and a display element. The display element is, for example, a transmissive liquid crystal display element, and the light source is a backlight source for the transmissive liquid crystal display element. Note, however, that the configuration of the image forming unit 11 is not limited to this.

For example, the display element can be a reflective liquid crystal display, an organic EL display, a micro-LED display, a digital micro-mirror device (DMD), an MEMS mirror, or a projector. In cases where a reflective liquid crystal display or a DMD is used as a display element, a light source illuminating the liquid crystal display or the DMD from the front side is employed. Further, in cases where a self-illuminated display element, such as an organic EL display or a micro-LED display, is used as a display element, a light source is built into the display element. Further, in cases where an MEMS mirror that is scanned across various angles is used as a display element, a laser light source that emits a narrow laser light beam toward the MEMS mirror is used as the light source.

The introductory optical system 12, which is composed of one or more mirrors, lenses, etc., is a collimating optical system that converts the display light, which is emitted from each point (pixel) on the display surface of the display element included in the image forming unit 11 so as to spread, into an approximately parallel light beam that differs in angle at each point.

The light guide 13 is an optical component configured to expand a light beam incident in approximately parallel and emit the expanded light beam as an approximately parallel light beam. For the light guide 13 having such an effect, various types and configurations are known. One example is the light guide described in FIG. 7 of Non-Patent Document 1, in which a mirror surface is formed on the incident side inside a flat, transparent substrate, and a number of beam splitter surfaces are formed on the emission side.

In this configuration of the light guide, a light beam incident on the substrate from the outside is reflected by the incident-side mirror surface, resulting in a total reflection condition, and propagates inside the substrate while repeating total reflections on a pair of opposing surfaces of the substrate. When the propagating light beam reaches the beam splitter surface, a part of the light beam is reflected and emitted from the substrate, while the remaining light beam is transmitted through the beam splitter surface and further propagates inside the substrate. By repeating the reflection of a part of the light beam and the transmission of the remaining light beam at a plurality of beam splitter surfaces, the incident light beam is expanded and emitted from the light guide.

In the HUD system of this embodiment, the light guide 13 is not of the configuration described above, but employs the system shown in FIG. 2 and described in Patent Document 1. That is, the light guide 13 is composed of a transparent first substrate 131, which is flat and internally features a reflective surface 1311 inclined at a predetermined angle to one surface of the flat plate, and a transparent second substrate 132, which has a flat surface 1322 on one side and a triangular wave-shaped uneven surface 1321 in cross-section on the other side.

One flat surface 1313 of the first substrate 131 and the flat surface 1322 of the second substrate 132 are closely adhered to each other with a planar beam splitter 133, which is formed by, e.g., optical coding, interposed between them. The angle of the reflective surface 1311 is determined such that the light beam reflected by the reflective surface 1311 satisfies the total reflection condition at the interface between the first substrate 131 and the external environment (air).

As shown in FIG. 2, the light beam introduced into the first substrate 131 from the introductory optical system 12 is once reflected by the reflective surface 1311. Thereafter, the light beam propagates inside the substrate 131 while repeating the total reflection on the opposing flat surfaces 1313 and 1312 of the first substrate 131. When the light beam reaches the beam splitter 133, a part of the light beam passes through the beam splitter 133 and is emitted from the uneven surface 1321 to the outside. The remaining light beam is reflected by the beam splitter 133, passes through the interior of the first substrate 131, reflects off the flat surface 1312, and then reaches the beam splitter 133 again. By repeating this process, the light beam is expanded and emitted from the light guide 13 in an oblique direction.

Of course, the light guide 13 can be appropriately modified as described in Patent Document 1, and a light guide other than the one described here, for example, a light guide with a configuration that uses a hologram to extract light beams from a substrate, can also be used.

The correcting lens 14 is an optical component configured by one lens or a combination of multiple lenses, which can deflect the direction of the light beam incident on the incident surface of the lens at each point on its incident surface, as will be described in detail later.

The optical path for displaying an image in this HUD system 1 will be described.

The display light, which includes the image formed on the display surface of the display element in the image forming unit 11 as information, is emitted from the display surface. The display light emitted in various directions from a single point on a display surface is parallelized in the introductory optical system 12. Further, the light emitted from different points on the display surface are parallelized in different directions in the introductory optical system 12. Therefore, the display light introduced into the light guide 13 from the introductory optical system 12 is a set of parallel light beams. Each light beam contains information about a different portion of the image formed on the display surface of the image forming unit 11, and each enters the light guide 13 at a different angle. The light guide 13 expands and ejects the light beam that is incident parallel to each other while maintaining the parallelism of the light beam.

In FIG. 2, the optical path of the display light emitted from a certain point on the display surface is shown. However, the light beams emitted from different points on the display surface and expanded by the light guide 13 are parallel light beams directed in directions different from the light beam shown in FIG. 2. In an HUD, it is important for the display light to reach the eyes of the observer while maintaining the parallelism of the light beams, in order for the virtual image generated by the display light to be superimposed on the exterior view and to be displayed well.

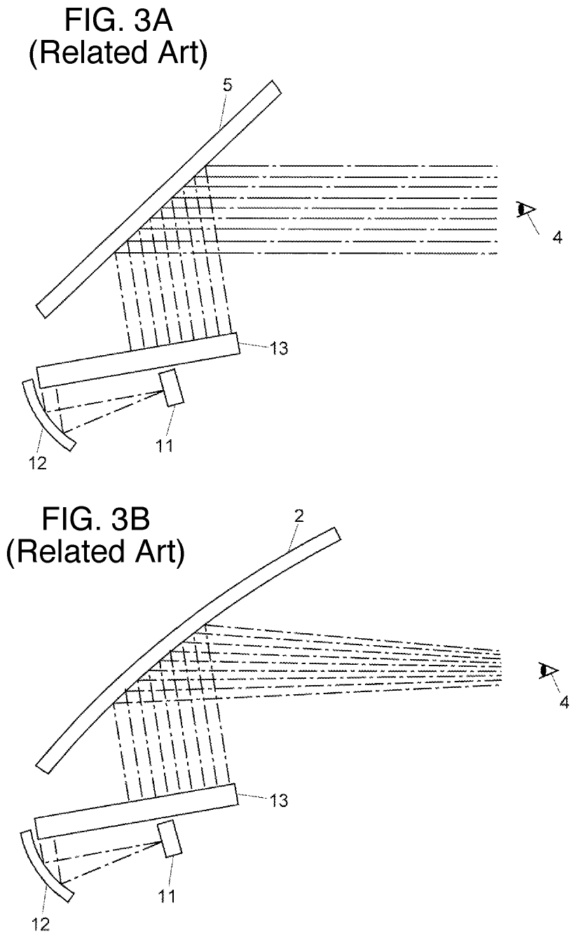

FIG. 3A is an optical path diagram schematically showing a light beam reaching the eyes 4 of the observer 3 in a case where the correcting lens 14 is not provided, and the combiner 5 has a flat reflective surface. As shown in the figure, the parallel light beams emitted from the light guide 13 impinge upon the combiner 5 and are reflected toward the eyes 4 of the observer 3 while maintaining their parallelism. In this case, the focus of the virtual image is theoretically located at infinity.

In contrast, a windshield 2 is at least partially curved in its longitudinal cross-sectional shape, as shown in FIG. 1. Its shape varies depending on the type and other factors of an automobile, and the cross-sectional shape can be quite complex. Further, as shown in the top plan view of FIG. 5, in a typical automobile, the windshield 2 has a symmetrically curved cross-sectional shape centered on the axis S. Moreover, the observer (driver) 3 is seated at a position offset from the axis S. Therefore, the cross-sectional shape of the windshield 2, positioned in front of the observer 3, is a non-axisymmetric curved surface. As described above, in the windshield 2, the shape of the surface that reflects the display light from the HUD system 1 is quite complex.

FIG. 3B is an example of an optical path schematically showing the light beams reaching the eyes 4 of the observer 3 in a case where the correcting lens 14 is not provided, and the reflective surface is the above-described windshield 2. As shown in the figure, the reflective surface of the windshield 2 is curved, and its curvature is not constant. Therefore, even if parallel light beams from the HUD system 1 impinge upon it, the reflected light beams do not become parallel but diverge in their traveling directions. Both the traveling direction and the degree of divergence vary depending on the position on the reflective surface. Therefore, the virtual image as seen from the observer 3 will be distorted, and if the position of the eyes 4 of the observer 3 shifts vertically, the position of the virtual image will move vertically.

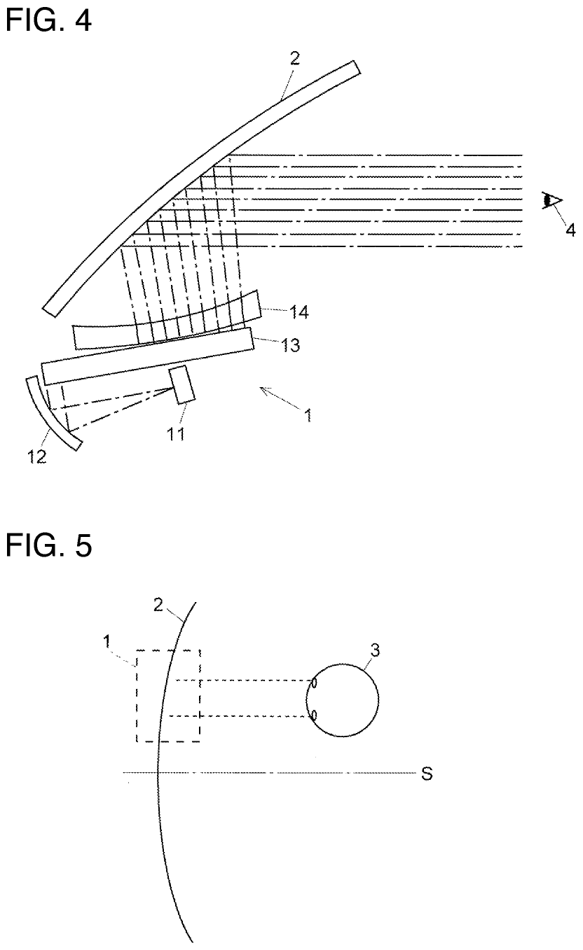

In the HUD system 1 of this embodiment, the correcting lens 14 has the function of bending, or deflecting, the directions of the light beams toward the windshield 2 such that the light beams entering parallel to the incident surface of the correcting lens 14 remain parallel after passing through the correcting lens 14 and being reflected by the windshield 2. FIG. 4 is an example of an optical path schematically illustrating the light beam that reaches the eyes 4 of the observer 3 in the HUD system 1. The light beams emitted from the light guide 13 are identical to those shown in FIG. 3, and the light beams directed to the eyes 4 of the observer 3 are equivalent to those depicted in FIG. 3A.

To deflect the light beam as described above, at least one of the surfaces of the correcting lens 14, either the incident surface or the emission surface has a freeform curved shape that corresponds to the shape of the reflective surface of the windshield 2. That is, either one surface may be a freeform curved surface, while the other surface may be a freeform curved surface, or can take a variety of shapes, such as a flat shape, a spherical shape, a toric shape, and a cylindrical shape. The shape of the freeform curved surface is designed to correspond to the shape of the reflective surface of the windshield 2.

Further, as shown in FIG. 5, the shape of the reflective surface of the windshield 2 is usually a non-axisymmetric curved surface, so the above-described freeform curved surface of the correcting lens 14 is also a non-axisymmetric freeform curved surface. Further, since the reflective surface (the surface facing the interior of the automobile) of the windshield 2 is usually concave, the above-described freeform curved surface of the correcting lens 14 has a shape having a negative optical power, i.e., a concave surface shape. As described above, the shape of the windshield 2 generally varies depending on the type and other factors of the automobile. Therefore, depending on the type of the automobile in which this HUD system 1 is installed, the correcting lens 14 to be employed can be changed to one with a different curved surface shape of the incident surface and/or the emission surface. In other words, it is possible to be compatible with various types of automobiles by using common components other than the correcting lens 14, which is located in the housing 10, and replacing only the correcting lens 14.

Due to the function of the correcting lens 14, the display light reflected by the windshield 2 reaches the eyes 4 of the observer 3 as parallel light beams. As a result, the image formed on the display surface of the image forming unit 11 is displayed in front of the eyes of the observer 3 as a good virtual image without any distortion or a viewpoint-dependent position shift. Further, the exterior light from the forward view information, such as the exterior view in front of the observer 3, passes through the windshield 2 and reaches the eyes 4 of the observer 3. In this way, the observer 3 can visually recognize the forward view information as well.

In this HUD system 1, the correcting lens 14 constitutes a part of the housing 10. That is, in a conventional HUD, a part of the housing 10 is made of a transparent (or translucent) cover to extract the display light from the inside of the housing 10 to the outside. However, in this HUD system 1, the correcting lens 14 is mounted in place of a cover. Thus, the correcting lens 14 prevents dust or the like from entering the housing 10 to serve the function of protecting the various components located inside.

The emission surface of the correcting lens 14, which is exposed to the outside of the housing 10, reflects the light arriving from the outside. When this reflected light reaches the eyes 4 of the observer 3, the observer 3 feels dazzled, resulting in reduced visibility of the exterior view and other objects. For this reason, it is preferable to determine the shape of the emission surface of the correcting lens 14 and the arrangement (orientation) of the correcting lens 14 so that the reflected light on the emission surface of the correcting lens 14 for the light incident surface coming from the outside of the vehicle through the windshield 2 into the vehicle is not directed in the direction where the eyes 4 of the observer 3 are located.

That is, in this HUD system 1, the shape of the incident surface and/or the emission surface of the correcting lens 14 and the arrangement of the correcting lens 14 are most important to ensure that the display light transmitted through and emitted from the correcting lens 14 becomes parallel light beams after being reflected by the windshield 2. In addition, the reflected light on the emission surface of the correcting lens 14 should not be directed toward the direction where the eyes 4 of the observer 3 are located, in relation to the incident light coming from the outside through the windshield 2 into the vehicle.

Note that although the above-described embodiment assumes that the HUD system is used in an ordinary automobile, it goes without saying that the head-up display device of the present disclosure can be used in various vehicles other than automobiles and various other moving objects that are driven or controlled by humans.

In such a case, the observer 3 may be positioned on the axis S instead of being offset from the axis S, as shown in FIG. 5. In such a case, it goes without saying that the incident surface and/or the emission surface of the correcting lens can be an axisymmetric freeform curved surface.

Further, it should be noted that the above-described embodiment is merely one example of the present disclosure, and it is obvious that any appropriate variations, modifications, additions, etc., within the scope of the intent of the present disclosure are included within the scope of the claims of this application.

### VARIOUS ASPECTS

It would be understood by those skilled in the art that the exemplary embodiments described above are specific examples of the following aspects.

### (Item 1)

A head-up display device according to the present disclosure is an HUD device that projects display light onto a windshield of a manned vehicle and directs the display light reflected by the windshield toward eyes of an observer to form a virtual image in front of the eyes of the observer. The HUD device includes:
an image emitting unit including an image forming unit for forming an image, the image emitting unit being configured to form parallel light beams different in angle at each location on the image and emit the light beams as display light;
a light guide configured to emit the light beams as the display light emitted from the image emitting unit by expanding the light beams while maintaining parallelism of the light beams; and
a correcting lens arranged on an optical path between the light guide and the windshield, the correcting lens having a curved surface shape that deflects a light transmission direction according to a curved surface shape of a reflective surface of the windshield so that the display light, in which the parallel light beams are expanded by the light guide, becomes parallel after being reflected by the windshield.

### (Item 2)

In the head-up display device as recited in the above-described Item 1, it may be configured such that the correcting lens has a light incident surface and a light emission surface, at least one of the light incident surface and the light emission surface being a freeform curved surface.

In the HUD device as recited in the above-described Item 1 or 2, regardless of the shape of the reflective surface of the windshield, the degree of parallelism of the light beam in each field of view becomes high, and its degree of spread becomes almost uniform after being reflected by the windshield, due to the action of the correcting lens. Therefore, according to the HUD device as recited in the above-described Item 1 and 2, it is possible to provide an HUD display with good visibility by preventing the occurrence of distortion of the HUD display and shifting of the display position even if the observer's viewpoint position shifts.

### (Item 3)

In the HUD device as recited in the above-described Item 2, it may be configured such that the HUD device is designed for a vehicle, and at least one of the light incident surface and the light emission surface of the correcting lens is a non-axisymmetric freeform curved surface.

According to the HUD device as recited in the above-described Item 3, it is possible to improve the visibility of the virtual image displayed in front of the eyes of the driver of the vehicle.

### (Item 4)

In the HUD device as recited in any one of the above-described Items 1 to 3, it may be configured such that the correcting lens is arranged at an installation angle or formed to have the curved surface shape such that reflected light from exterior light arriving through the windshield does not reach the eyes of the observer.

According to the HUD device as recited in the above-described Item 4, it is possible to reduce the glare felt by the observer due to the reflected light from the correcting lens. Thereby, the visibility of the exterior view and the virtual image superimposed on it can be improved.

### (Item 5)

In the HUD device as recited in any one of the above-described Items 1 to 3, it may be configured such that the correcting lens serves also as a cover forming a part of a housing that accommodates the image emitting unit and the light guide.

According to the HUD device as recited in the above-described Item 5, it is possible to reduce the number of optical components housed within the housing and minimize the size of the housing.

### DESCRIPTION OF REFERENCE SYMBOLS

1: HUD system
10: Housing
11: X-ray image forming unit
12: Introductory optical system
13: Light guide
131: First substrate
1311: Reflective surface
1312, 1313: Flat surface
132: Second substrate
1321: Uneven surface
1322: Flat surface
133: Beam splitter
14: Correcting lens
2: Windshield
3: Observer
4: Eyes

1. A head-up display device that projects display light onto a windshield of a manned vehicle and directs the display light reflected by the windshield toward eyes of an observer to form a virtual image in front of the eyes of the observer, the head-up display device comprising:
an image emitting unit including an image forming unit for forming an image, the image emitting unit being configured to form parallel light beams different in angle at each location on the image and emit the light beams as display light;
a light guide configured to emit the light beams as the display light emitted from the image emitting unit by expanding the light beams while maintaining parallelism of the light beams; and
a correcting lens arranged on an optical path between the light guide and the windshield, the correcting lens having a curved surface shape that deflects a light transmission direction according to a curved surface shape of a reflective surface of the windshield so that the display light, in which the parallel light beams are expanded by the light guide, becomes parallel after being reflected by the windshield.

2. The head-up display device as recited in claim 1,
wherein the correcting lens has a light incident surface and a light emission surface, at least one of the light incident surface and the light emission surface being a freeform curved surface.

3. The head-up display device as recited in claim 2,
wherein the head-up display device is designed for a vehicle, and
wherein at least one of the light incident surface and the light emission surface of the correcting lens is a non-axisymmetric freeform curved surface.

4. The head-up display device as recited in claim 1,
wherein the correcting lens is arranged at an installation angle or formed to have the curved surface shape such that reflected light from exterior light arriving through the windshield does not reach the eyes of the observer.

5. The head-up display device as recited in claim 1,
wherein the correcting lens serves also as a cover forming a part of a housing that accommodates the image emitting unit and the light guide.
